(19) United States
(12) Patent Application Publication
(10) Pub. No.: US 2002/0065039 A1
(43) Pub. Date: May 30, 2002

(54) Assembly comprising a cabinet and a system for communicating by radiofrequency waves with objects placed in the cabinet

(76) Inventors: Philippe Benezech, Nantes (FR); Olivier Bru, Orvault (FR)

Correspondence Address: YOUNG & THOMPSON, 745 SOUTH 23RD STREET 2ND FLOOR, ARLINGTON, VA, 22202

(21) Appl. No.: 09/993,713

(22) Filed: Nov. 27, 2001

(30) Foreign Application Priority Data
Nov. 27, 2000 (FR) 0015287

(51) Int. Cl. H04B 7/14

(52) U.S. Cl. 455/15; 455/20; 455/41

(57) ABSTRACT

The assembly comprises:

a work cabinet (2) itself comprising walls whose inside surfaces delimit a work space (9), the cabinet being adapted to subject an object placed in the work space to at least one predetermined physical or chemical condition,

a system (3) for communicating information by radiofrequency waves comprising at least one antenna (16) for communicating by radiofrequency waves with objects (20) placed in the work space and furnished with means (22) for transmitting and/or receiving radiofrequency waves, characterized in that the antenna (16) is disposed outside the work space (9) and is separated therefrom by a part (11) at least of a wall (5), which part is transparent, at least opposite the antenna, to the radiofrequency waves used by the communication system.

Application for example to the biological field.

The present invention relates to an assembly of the type comprising:

a work cabinet itself comprising walls whose inside surfaces delimit a work space,

a system for communicating information by radiofrequency waves comprising at least one antenna for communicating by radiofrequency waves with objects placed in the work space and furnished with means for transmitting and/or receiving radiofrequency waves.

The invention applies in particular to the processing of biological samples or materials and especially to the culturing, to the preserving and/or to the analysis of cells and/or microorganisms.

An assembly of the aforesaid type is known from the document WO-00/33005 in which the cabinet is a thermostatically controlled, for example refrigerated, cabinet and the objects are receptacles containing biological samples. These receptacles are furnished with radiofrequency transponders for identifying the samples which they contain. The system for communicating by radiofrequency waves makes it possible to identify the samples inserted into the cabinet with a view to monitoring its contents, but also to provide information to the radiofrequency transponders carried by the receptacles regarding the processing which the samples have undergone in the cabinet, for example a thermal cycle. The communication system of this document comprises antennas each placed on a shelf disposed in the work space.

It is noted that in such a cabinet the antennas, and their connections to the remainder of the communications system, may be subjected to conditions of temperature, humidity, pressure or to environments which may impair the proper operation and the reliability of the communication system.

Moreover, the cleaning and the decontamination of the surfaces delimiting the work space are impeded by the antennas. Now, such cleaning and decontamination are required regularly for the applications mentioned above.

One aim of the invention is to solve this problem by providing an assembly of the aforesaid type which makes it easier to clean and decontaminate the work space of the cabinet.

Accordingly, the subject of the invention is an assembly of the aforesaid type, characterized in that the antenna is disposed outside the work space and is separated therefrom by a part at least of a wall, which part is transparent, at least opposite the antenna, to the radiofrequency waves used by the communication system.

According to particular embodiments, the assembly can comprise one or more of the following characteristics, taken in isolation or according to all technically possible combinations:

the antenna is disposed in said wall, said transparent part being an inside part of the wall,

the antenna is disposed outside said wall, which wall is transparent over its entire thickness to the radiofrequency waves used by the communication system,

the antenna is carried by said wall,

said transparent part is movable between an opening position of the cabinet, where the transparent part frees an opening for access to the work space, and a closure position of the cabinet, where the transparent part shuts off the access opening,

said wall comprises two movable doors of which a first inside door forms said transparent part,

the cabinet is a thermostatically controlled cabinet,

said transparent part comprises a partition for separating the antenna from the work space and a layer for thermally insulating the antenna from the work space.

The invention will be better understood on reading the description which follows, given merely by way of example, and while referring to the appended drawings in which:

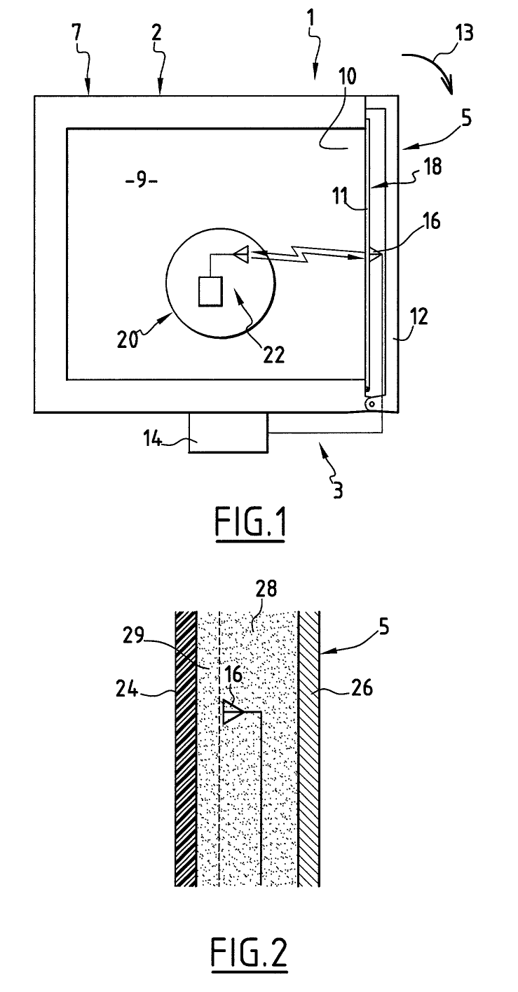

FIG. 1 is a diagrammatic view from above of an assembly according to the invention, the upper wall of the cabinet not having been represented, and

FIG. 2 is a partial diagrammatic section illustrating the structure of the door of the cabinet of a variant of the assembly of FIG. 1.

FIG. 1 represents an assembly 1 comprising a thermostatically controlled cabinet 2 for the processing of biological samples, and a system 3 for communicating information by radiofrequency waves.

It is recalled that radiofrequency waves are electromagnetic waves. In the examples described hereinbelow, the frequencies of the waves which may be used will for example be 125 kHz, 13.56 MHz and 2.45 GHz. However, other frequencies may of course be envisaged.

The cabinet 2 has a substantially parallelepipedal shape and comprises four side walls of which a first, denoted by the reference 5, forms a double front door. The other side walls of the cabinet 2 and its lower and upper walls form a vessel 7.

The walls of the cabinet 2 delimit internally a confined work space 9, suitable for carrying out work.

The front face of the vessel 7 is open so as to form an opening 10 for access to the work space 9, which opening may be shut off and/or freed by the wall 5.

More precisely, the wall 5 comprises a first inside door 11 and a second outside door 2.

The first door 11 is for example made of glass or plexiglass (registered trademark). The second door 12 has for example, like the walls forming the vessel 7, a double-envelope structure comprising an inside panel made of plastic, a metal outside panel, and a layer of a thermally insulating material disposed between the inside and outside panels.

The two doors 11 and 12 are articulated on one and the same side of the vessel 7 so as to be able to be opened independently by rotation in the direction of the arrow labeled by the reference 13 in FIG. 1. The opening of the door 12 only allows visual monitoring, through the door 11 transparent to optical waves, of the progress of the operation carried out in the work space 9.

The cabinet 2 is furthermore furnished with heating means (not represented) so as to constitute an oven.

The system 3 comprises an information processing and communication unit 14 and at least one antenna 16 hooked up electrically to the unit 14.

In a conventional manner, the unit 14 can comprise a computer, means for storing data in the form of any appropriate memory, a clock, and a module for transmitting and receiving radiofrequency waves.

The antenna 16 which is a conventional antenna is carried by the outside surface 18 of the inside door 11, to which it is for example glued. Thus, the antenna 16 is disposed outside the work space 9 and is insulated therefrom by the entire thickness of the inside door 11 which forms a partition for separating the antenna 16 from the space 9.

when a receptacle 20, containing a biological sample and equipped with a radiofrequency identification transponder 22 tuned with the radiofrequency module of the unit 14, is placed in the work space 9, the antenna 16 can via radiofrequency waves exchange information with the transponder 22, since the inside door 11 which separates the antenna 16 from the work space 9 is completely transparent to the radiofrequency waves used by the communication system 3.

The communication system 3 can thus interrogate the transponder 22 and receive in response the identifier of the sample contained in the receptacle 20, but also exchange any other information with the transponder 22 in a conventional manner, for example by providing it with information relating to the thermal cycle undergone by the sample inside the cabinet 2.

The antenna 16 being insulated from the work space 9 and hence from its atmosphere, it is not subjected to the physical and chemical conditions to which the sample of the receptacle 20 is subjected. Thus, the antenna 16 is protected from physical and chemical attacks and the communication system 3 operates satisfactorily.

Moreover, the cleaning of the cabinet 2 and in particular of the inside surfaces of the walls delimiting the work space 9 is made easier.

Finally, the position of the antenna 16 also makes it easier to hook it up to the unit 14 since it is not necessary to pass completely, that is to say over its entire thickness, through a wall of the cabinet 2, to ensure such a hookup.

In the variant of FIG. 2, the cabinet 2 constitutes for example a refrigerator and the wall 5 is a simple door with a double-envelope structure. The movable wall or door 5 thus comprises an inside panel 24, an outside panel 26 and a layer 28 of a thermally insulating material disposed between the panels 24 and 26.

The inside panel 24 is for example made of a plastic and the layer 28 for example of polyurethane foam, these two materials being transparent to the radiofrequency waves used by the communication system 3 and by the transponders 22 of the receptacles 20 intended to be placed in the cabinet 2.

The outside panel 26 is for example made of metal.

The antenna 16 is disposed in the wall 5, between the panels 24 and 26, in proximity to the panel 24. The antenna 16 is embedded in the layer 28. In a variant it can be in contact with the inside panel 24.

The antenna 16 is insulated from the atmosphere of the work space 9 by the inside panel 24 of the wall 5 and an inside region 29 (one boundary of which is represented dashed) of the layer 28, thereby making it possible to limit the physical and chemical attacks of the antenna 16 and to make it easier to clean the cabinet 2. In particular, the presence of the region 29, in addition to the panel 24 which forms a separating partition, enables the antenna 16 and its electrical connections to be effectively thermally insulated from the atmosphere of the work space 9. Thus, the system 3 operates reliably and satisfactorily even if the temperature prevailing in the space 9 reaches for example −80° C.

In other variants which are not represented, the or each antenna 16 can be disposed on or in a wall of the cabinet 2 other than the movable wall 5. It may for example be the rear side wall opposite the movable wall 5.

Additionally, it is not necessary for the part of this wall situated between the or each antenna 16 and the work space 9 to be transparent, over the whole of its transverse dimensions, to the radiofrequency waves used. Thus, only the part of the relevant wall situated opposite the antenna 16, that is to say disposed in the cone of reception and of transmission of the or of each antenna 16, may be transparent to the radiofrequency waves used.

In yet another variant, the antenna 16 can be disposed outside the cabinet 2 on the outside surface of one of its walls which is transparent over its entire thickness to the radiofrequency waves used.

Finally, it is appreciated that the above principles may be applied to assemblies 1 whose communications systems 3 cater for the transmission and reception of information by radiofrequency waves, for transmission alone or for reception alone.

It is also appreciated that the above principles apply to all types of work cabinet, whether or not thermostatically controlled, and in particular to incubators, to ovens and to refrigerators.

The expression thermostatically controlled cabinet should be understood to mean a cabinet making it possible to maintain the temperature inside its work space substantially constant. This term therefore covers in particular a cabinet with insulating walls and containing a source of cold, such as ice or dry ice (carboglace, registered trademark), or a source of heat, so as to maintain its inside temperature substantially constant.

More generally, the work carried out in the cabinet can consist in subjecting objects contained in the work space to specified physical conditions, for example to a temperature as indicated earlier or to a specified pressure, and/or to specified chemical conditions, for example to a CO₂-monitored and humidity-monitored atmosphere.

More generally, if the cabinet possesses several shelves for supporting receptacles 20 dividing the work space 9 into several compartments, an antenna 16 can be disposed opposite each compartment of the work space 9, so as to enable the system 3 to locate the samples in the work space 9.

1. An assembly comprising:
a work cabinet having walls whose inside surfaces delimit a work space that is adapted to receive an object to be subjected to a chemical or physical condition; and
a communication system that includes a first communication device outside said work space, a radio frequency antenna connected to said first communication device, and a second communication device that is to be associated with the object in said work space, said first communication device communicating with said second communication device via said antenna,
wherein at least a part of one of said walls of said work cabinet is transparent to a radio frequency used by said antenna, said antenna being separated from said work space by said at least a part of one of said walls.

2. The assembly of claim 1, wherein said at least a part of one of said walls is an inside part of said one of said walls and wherein said antenna is in said one of said walls.

3. The assembly of claim 1, wherein said at least a part of one of said walls is an entire thickness of said one of said walls and wherein said antenna is outside said one of said walls.

4. The assembly of claim 3, wherein said antenna is carried by said one of said walls.

5. The assembly of claim 1, wherein said one of said walls is movable between an open position that provides access to said work space and a closed position that bars access to said work space.

6. The assembly of claim 5, wherein said work cabinet comprises an inside door and an outside door, and wherein said inside door is said one of said walls.

7. The assembly of claim 1, wherein said at least a part of one of said walls comprises a partition and a layer of thermally insulating material.

8. The assembly of claim 1, wherein said second communication device is an identification transponder.

9. An assembly comprising:
a work cabinet that is thermostatically controlled and that has walls whose inside surfaces delimit a work space that is adapted to receive an object ; and
a radio frequency communication system including an antenna that communicates by radio frequency waves with a communication device associated with the object in said work space,
at least a part of one of said walls being transparent to the radio frequency waves, said antenna being outside said work space and separated from said work space by said at least a part of one of said walls.

10. An assembly comprising:
a work cabinet that has walls whose inside surfaces delimit a work space that is adapted to receive an object to be subjected to a chemical or physical condition; and
a radio frequency communication system including an antenna that is carried by said work cabinet and that communicates by radio frequency waves with a communication device associated with the object in said work space,
at least a part of one of said walls being transparent to the radio frequency waves, said antenna being separated from said work space by said at least a part of one of said walls.
